(19) United States
(12) Patent Application Publication
(10) Pub. No.: US 2025/0305478 A1
(43) Pub. Date: Oct. 2, 2025

(54) VERTICAL AXIS TURBINES AND BLADES FOR VERTICAL AXIS TURBINES

(71) Applicant: Daniel LAHEY, Mio, MI (US)

(72) Inventor: Daniel LAHEY, Mio, MI (US)

(21) Appl. No.: 18/864,867

(22) PCT Filed: May 12, 2023
(86) PCT No.: PCT/US2023/021975

§ 371 Date: Nov. 11, 2024

Related U.S. Application Data
(60) Provisional application No. 63/341,299, filed on May 12, 2022.

(51) Int. Cl. F03D 3/00; F03B 17/06; F03D 3/06

(52) U.S. Cl. CPC F03D 3/011; F03B 17/062; F03D 3/066; F05B 2210/16; F05D 2240/301

(57) ABSTRACT

The disclosure relates to vertical axis turbines comprising a blade support and two or more turbine blades. The blade support is configured to rotate about a central axis. The two or more turbine blades are secured to the blade support and configured to orbit the central axis during rotation of the blade support around the central axis. Each of the two or more turbine blades includes a first edge opposed to a second edge. The first edge is rounded and the second edge is sharp relative to the first edge, and includes first and second sides that extend between the first and second edges. At least one of the first and second sides includes a hook shaped recess, is configured to pivot relative to the blade support about a pivot axis that is offset from and parallel to the central axis.

### CROSS REFERENCE TO RELATED APPLICATION

This application claims priority to U.S. Provisional Patent Application No. 63/341,299, filed May 12, 2022, the entire contents of which are incorporated herein by reference.

### TECHNICAL FIELD

The disclosure relates to vertical axis turbines useful for converting potential energy of a fluid such as wind or water to mechanical/rotational energy and eventually to electrical energy. The disclosure also relates to blades for vertical axis turbines.

### BACKGROUND

The demand for renewable energy is on the rise today, especially in view of the effects on the global climate resulting from the use of non-renewable energy sources such as fossil fuels such as coal, petroleum, and natural gas. Wind energy is one of the most abundant and cost-effective forms of renewable energy, which has led to an increase in the use of wind turbines.

Wind energy is conventionally converted to electricity by way of a wind turbine. Wind turbines are generally categorized as horizontal axis wind turbines (“HAWTs”) or vertical axis wind turbines (“VAWTs”). A VAWT is more efficient in turbulent air found at low altitudes, simpler, and significantly cheaper to build and maintain than a HAWT. Furthermore, VAWTs can be installed at various locations, including rooftops, highways, and parking lots.

VAWTs primarily fall into two different types: Savonius-type and Darrieus-type. Savonius-type turbines, the least efficient of two types, operate using a difference in drag coefficients between the front of the blade and the back. Darrius-type turbines operate similarly to a standard HAWT, using airfoils to gain speed as the blades travel perpendicular to the wind, but the axis of rotation is vertical.

However, problems exist with both types of VAWTs. For example, current VAWTs employ blades that harness wind energy during only a relatively small portion of rotation, thereby rendering the turbines less efficient than HAWTs having blades that harness wind energy during the entire rotation. Further, although it is known to protect HAWTs from the problem of overspeed, i.e., when the blades spin too fast thereby causing the turbine to malfunction, there has yet to be a solution to prevent this problem in VAWTs.

The present disclosure addresses these concerns by providing vertical axis turbines that can be used to convert potential energy from a fluid such as wind or water to mechanical/rotational energy and eventually to electrical energy, and blades with designs for use in vertical axis turbines that can achieve such benefits.

### SUMMARY

The disclosure relates to a vertical axis turbine that includes a blade support and two or more turbine blades. The blade support configured to rotate about a central axis. The two or more turbine blades secured to the blade support and configured to orbit the central axis during rotation of the blade support around the central axis. Each of the two or more turbine blades includes a first edge opposed to a second edge, wherein the first edge is rounded and the second edge is sharp relative to the first edge; includes first and second sides that extend between the first and second edges, wherein at least one of the first and second sides includes a hook shaped recess; and is configured to pivot relative to the blade support about a pivot axis that is offset from the central axis.

Various embodiments include a cross-section of a portion of each of the two or more turbine blades that may define a wedge shape that expands from the second edge toward the first edge. A thickness of each of the two or more turbine blades may increase in a direction from the second edge toward the first edge. The first and second sides may extend between first and second ends of the respective turbine blade, wherein at least one of the first and second ends may be pivotally secured to the blade support. The blade support may include separate first and second blade supports, wherein the first blade support pivotally supports the first side, and the second blade support pivotally supports the second side. The at least one of the first and second sides that includes the hook shaped recess may include one or more ribs that divide the hook shaped recess into separate cavities. The hook shaped recess may be configured to redirect airflow greater than 90 degrees and less than 180 degrees.

In some embodiments, the pivot axis may be offset from a center of mass of the respective turbine blade. The pivot axis may be disposed between the first edge and a center of mass of the respective turbine blade.

In some embodiments, the vertical axis turbine may also include a control spring configured to bias pivotal rotation of the turbine blade about the pivot axis in a first direction, wherein orbital movement of the turbine blade around the central axis is configured to bias pivotal rotation of the turbine blade in a second direction about the pivot axis opposite from the first direction. A spring constant of the control spring may be configured to prevent pivotal rotation of the turbine blade about the pivot axis unless a speed of the orbital movement of the turbine blade around the central axis exceeds a predefined threshold. A rotational stop may be included on each of the two or more turbine blades and may be configured to limit pivotal rotation of the respective turbine blade about the pivot axis. The pivot axis may be parallel to the central axis.

In some embodiments, the hook shaped recess may be on the second side, wherein a chord line of each turbine blade connects points on the first and second edges furthest from one another, wherein a surface of the hook shaped recess may be disposed on the opposite side of the chord line as the first side of the respective turbine blade. Both the first and second sides may each include separate hook shaped recesses. A cross-section of each of the two or more turbine blades may be symmetrical.

Various embodiments include a vertical axis turbine comprising a blade support configured to rotate about a central axis; and two or more turbine blades secured to the blade support and configured to orbit the central axis during rotation of the blade support around the central axis, wherein each of the two or more turbine blades is configured to pivot relative to the blade support about a pivot axis that is offset from the central axis, includes a first edge that is rounded and a second edge, opposed to the first edge, that is sharp relative to the first edge, and includes first and second sides that extend between the first and second edges, wherein each of the first and second sides includes a hook shaped recess.

Various embodiments include a vertical axis turbine comprising a blade support configured to rotate about a central axis; and two or more turbine blades secured to the blade support and configured to orbit the central axis during rotation of the blade support around the central axis, wherein each of the two or more turbine blades is configured to pivot relative to the blade support about a pivot axis that is offset from the central axis, includes a first edge that is rounded and a second edge, opposed to the first edge, that is sharp relative to the first edge, and includes first and second sides that extend between the first and second edges, wherein the first side includes a surface that bows away from a chord line that extends from the first edge to the second edge, wherein the second side includes a hook shaped recess.

### BRIEF DESCRIPTION OF FIGURES

The accompanying drawings, which are incorporated herein and constitute part of this specification, illustrate exemplary embodiments of the disclosure, and, together with the general description given above and the description provided herein, serve to explain various features of the disclosure.

FIG. 1 is a perspective view of an exemplary vertical axis turbine according to various embodiments of the disclosure.

FIG. 2A is a top perspective view of an exemplary blade assembly according to the disclosure.

FIG. 2B is a bottom perspective view of the exemplary blade assembly of FIG. 2A according to the disclosure.

FIG. 3A is a first side perspective view of an exemplary turbine blade according to various embodiments of the disclosure.

FIG. 3B is a second side perspective view of the exemplary turbine blade of FIG. 3A according to the disclosure.

FIG. 3C is a cross-sectional view of the turbine blade of FIGS. 3A and 3B at C-C in FIG. 3B according to the disclosure.

FIG. 4 is a cross-sectional view of an alternative turbine blade according to the disclosure.

FIG. 5 is a cross-sectional view of a further alternative turbine blade according to the disclosure.

FIGS. 6A and 6B are top views of a turbine blade and portion of a radially extending arm of a blade support with a pivotal control system according to the disclosure.

FIG. 7A is a cross-sectional top view of a blade assembly rotating below a predefined threshold speed according to the disclosure.

FIG. 7B is a cross-sectional top view of one of the turbine blades in FIG. 7A in four different orbital positions according to the disclosure.

FIG. 8A is a cross-sectional top view of a blade assembly rotating above a predefined threshold speed according to the disclosure.

FIG. 8B is a cross-sectional top view of one of the turbine blades in FIG. 8A in four different orbital positions according to the disclosure.

FIG. 9A is a cross-sectional top view of a blade assembly rotating well below a predefined threshold speed according to the disclosure.

FIG. 9B is a cross-sectional top view of one of the turbine blades in FIG. 9A in four different orbital positions according to the disclosure.

FIGS. 10A-10C are cross-sectional top views of a further alternative blade assembly rotating at various speeds relative to a predefined threshold speed according to the disclosure.

It is to be understood that the foregoing and following descriptions are exemplary and explanatory only and are not intended to be restrictive of any subject matter claimed.

### DETAILED DESCRIPTION

The disclosure relates to vertical axis wind turbines which have improved efficiency and/or reduced risk of overspeed. In various embodiments, vertical axis turbines according to the disclosure are configured to increase the rotation of the blades, have a low drag coefficient on the leading edge of the blades, and/or have a high drag coefficient on the trailing edge of the blades, which can increase the efficiency of the turbine. In some embodiments, vertical axis turbines according to the disclosure are configured to change the direction of the blades relative to the axis of rotation, which can provide protection from negative effects of overspeed. The disclosure also relates to blades for vertical axis turbines where the blades have a design that provides benefits such as improved efficiency and/or reduced risk of overspeed.

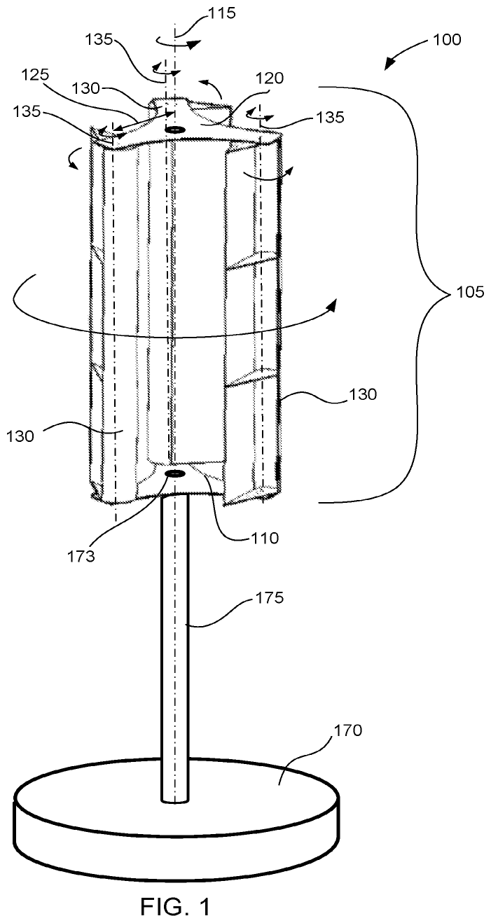

FIG. 1 illustrates a vertical axis turbine 100 having a blade assembly 105 comprising a blade support 110, 120 and two or more turbine blades 130 secured thereto. The blade support 110, 120 is configured to rotate about a central axis 115. The two or more turbine blades 130 are configured to orbit the central axis 115 during rotation of the blade support 110, 120 around the central axis 115. Each of the two or more turbine blades 130 is configured to pivot relative to the blade support 110, 120 about a pivot axis 135 that is offset from the central axis 115. The offset distance 125 between the central axis 115 and the pivot axis 135 may be optimized to allow the two or more turbine blades 130 to capture wind energy, while still being able to pivot in accordance with various embodiments. In various embodiments, the pivot axis 135 is parallel to the central axis 115. Alternatively, in some embodiments, the offset between the central axis 115 and the pivot axis 135 may be an angular offset when the central axis 115 and the pivot axis 135 are designed not to be parallel to one another.

The blade support 110, 120 may include a first blade support 110 and a second blade support 120 separate from the first blade support 110. The first blade support 110 may pivotally support a first end of each of the two or more turbine blades 130 and the second blade support 120 may pivotally support a second end of each of the two or more turbine blades 130, opposite the first end. At least one of the first and second blade supports 110, 120 may be formed as a plate with a central coupling 173 that connects the blade assembly 105 to a base support structure, such as a base 170 and support mast 175. The base 170 may contain generators, transformers, and/or other components for collecting and/or transferring power captured by the vertical axis turbine 100 for storage and/or use. The base support structure (e.g., base 170) may be heavy enough to fixedly support the blade assembly 105 in use. Alternatively, the base support structure may be attached or otherwise fixedly secured to a support surface, such as the ground, part of a building (e.g., a rooftop), structure, the sea floor, or any other support surface, structure, and/or mechanism.

Although the support mast 175 is illustrated as being coupled only to the first blade support 110, at a lower end of the blade assembly 105, alternatively the second blade support 120 may be the only support holding the blade assembly 105 from an upper end. In this way, the blade assembly 105 would hang, suspended from above at the second blade support 120 with the base support structure located above that. As a further alternative, the support mast 175 may extend through the first blade support 110 all the way to the second blade support 120 to provide rotational support directly to both the first and second blade supports 110, 120. Thus, the second blade support 120 may also include a central coupling 173 for connecting to the support mast 175.

The central coupling 173 may include bearings to support free rotation of the blade assembly 105 relative to the base 170. Alternatively, the central coupling 173 may connect directly to the base 170, without the need for a support mast (e.g., 175). In addition, rather than having a support structure (e.g., the base 170 and/or the support mast 175) only at one end of the blade assembly 105, a frame structure may be included that rotatably couples to both the first and second blade supports without an internal support mast (e.g., 175) extending therebetween. In this way, an alternative support structure could be coupled to the top and bottom (in the orientation shown in FIG. 1) of the blade assembly 105 to provide rotational support thereto.

Although the blade support 110, 120 is illustrated with a first blade support 110 and a second blade support 120, alternatively the blade assembly 105 may include only one blade support, such as the first blade support 110, leaving the second side of each of the two or more turbine blades 130 unconnected to one another at one end.

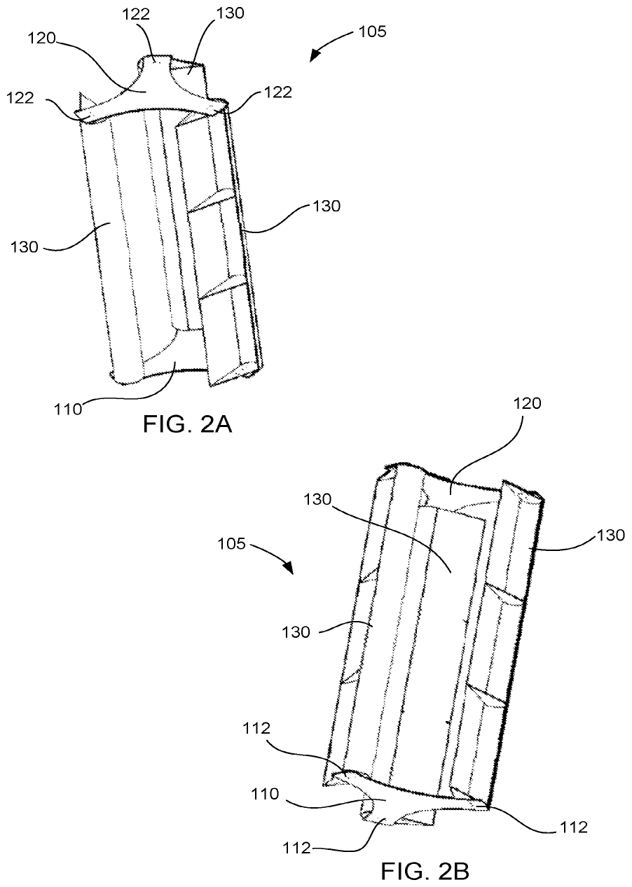

With reference to FIGS. 2A and 2B and in accordance with various embodiments, at least one of the first and second blade supports 110, 120 may be formed as a central plate with one radially extending arm 112, 122 configured to pivotally support one of the two or more turbine blades 130. Alternatively, the first and/or second blade supports 110, 120 may be formed as virtually any shape, such as circular or other geometrically shaped plate. The pivotal support provided by the first and/or second blade supports 110, 120 allows the turbine blades 130 to pivot about their respective pivot axis (e.g., 135) as the turbine blades 130 orbit the central axis (e.g., 115).

Although the blade assembly 105 is illustrated as having three (3) turbine blades 130, alternatively, the blade assembly 105 may have only two (2) turbine blades 130 or more than three (3) turbine blades 130. In accordance with various embodiments, the turbine blades 130 of the blade assembly 105 are evenly spaced around the central axis 115.

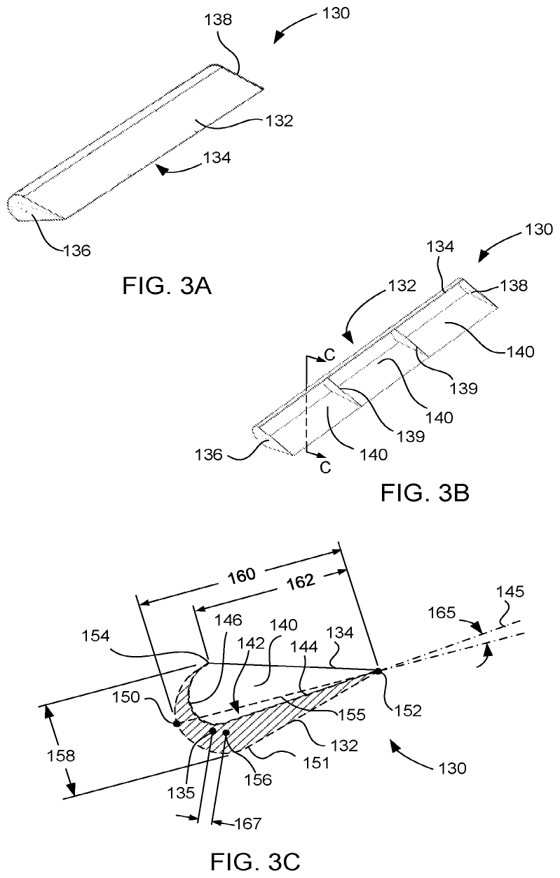

With reference to FIGS. 3A-3C, each of the two or more turbine blades 130 includes a first side 132 (e.g., the top side in the orientation shown in FIG. 3A) and a second side 134 (e.g., the bottom side in the orientation shown in FIG. 3A) that is opposed to the first side 132. In addition to being pivotally supported, each of the two or more turbine blades 130 includes a first edge 150 and a second edge 152 opposed to the first edge 150. The first and second edges 150, 152 may each extend across the entire length of the turbine blade 130. The first and second edges 150, 152 correspond to the furthest edges from one another on a cross-section of turbine blade 130. Thus, an imaginary line connecting the first and second edges 150, 152 defines a chord line 155 of the turbine blade 130. The first edge 150 appears and in some pivotal orientations functions similar to the leading edge of an airfoil. In addition, the second edge 152 appears and in some pivotal orientations functions similar to the trailing edge of an airfoil. In this way, the first edge 150 is rounded, while the second edge 152 is sharp relative to the first edge 150.

In various embodiments, the first side 132 of each turbine blade 130 includes a first surface 151 that bows away from the chord line 155 extending between first and second edges 150, 152. In contrast, the second side 134 of each turbine blade 130 includes a hook shaped recess 140. In various embodiments, the hook shaped recess 140 may include one or more ribs 139 that divide the hook shaped recess 140 into separate cavities. The first and second sides 132, 134 may extend from the first end 136 to the second end 138 of the respective turbine blades 130. The first and second ends 136, 138 may be formed as tear shaped end caps. At least one of the first and second ends 136, 138 may be pivotally secured to the blade support (e.g., 110, 120).

In various embodiments, the hook shaped recess 140 may be formed as a concave depression that is asymmetric relative to the chord line 155 between the first and second edges 150, 152. A recess surface 142 of the hook shaped recess 140 may extend from the second edge 152 to a third edge 154. Thus, an aperture of the hook shaped recess 140 is bounded by the second and third edges 152, 154. An aperture length 162, which is the shortest distance between the second edge 152 and the third edge 154, may be shorter than a chord length 160, which is the shortest distance between the first edge 150 and the second edge 152. The recess surface 142 may be defined by a planar surface portion 144 and a curved surface portion 146. The planar surface portion 144 may extend as a flat planar surface from the second edge 152 toward the first edge 150, but does not reach the first edge 150. After the planar surface portion 144, the curved surface portion 146 curls around and away from the first edge 150 until reaching the third edge 154. In this way, the curved surface portion 146 of the recess surfaces 142 curves back toward the second edge 152. The third edge 154 may form, what appears in cross-section, as a sharp point of a hook and the second edge 152 would then correspond to the opposite end of the hook. The recess surface 142 is thus configured to permit the bulk of the air to flow in the same direction along the planar surface portion 144 until it is sharply redirected generally back in the direction from which it came. For example, the redirection of airflow may be about 90 degrees, about 100 degrees, about 110 degrees, about 120 degrees, about 130 degrees, about 140 degrees, about 150 degrees, about 160 degrees, about 170 degrees, about 180 degrees, about 190 degrees, or about 200 degrees, including all ranges and subranges thereof. In some embodiments, the redirection of airflow may be less than 180 degrees in order to avoid creating whirlpools of airflow within the hook shaped recess 140. Thus, various embodiments may redirect airflow greater than 90 degrees, but less than 180 degrees.

Each of the two or more turbine blades 130 may include a cross-section, as shown in FIG. 3C, with a portion thereof that defines a wedge shape (i.e., a wedge-shaped portion) that expands from the second edge 152 toward the first edge 150. In this way, a thickness of each of the two or more turbine blades increases in a direction from the second edge 152 toward the first edge 150. That thickness may then reduce to another relatively sharp edge at the third edge 154. Without being limited by theory, the wedge shape may improve functioning and harness air flow on both the windward and leeward sides of the respective turbine blade 130. Various embodiments may use a particular drag ratio for the wedge-shaped portion, which is defined by a ratio of a length of the wedge-shape portion over a thickness of a thickest portion thereof. The drag ratio may be at least 2-to-1, at least 2.5-to-1, at least 3-to-1, at least 3.5-to-1, at least 4-to-1, at least 4.5-to-1, at least 5-to-1, at least 5.5-to-1, at least 6-to-1, at least 6.5-to-1, at least 7-to-1, at least 7.5-to-1, or at least 8-to-1, or may, for example, range from any of the foregoing up to 12-to-1, up to 11.5-to-1, up to 11-to-1, up to 10.5-to-1, up to 10-to-1, up to 9.5-to-1, or up to 9-to-1.

In various embodiments, the planar surface portion 144 of the recess surface 142 may be disposed in an offset plane 145 that is not parallel to the chord line 155. In this way, the offset plane 145 may have an angular offset 165 of a few degrees from a plane on which the chord line 155 is disposed, e.g., at least 2, at least 3, at least 4, at least 5, at least 6, at least 7, at least 8, at least 9, at least 10, at least 11, at least 12, at least 13, at least 14, or at least 15 degrees, up to for example 20, up to 19, up to 18, up to 17, up to 16, or up to 15, including any range using the foregoing as upper and/or lower limits, for example may range from about 2 to about 20 degrees.

In various embodiments, the pivot axis 135 is offset from a center of mass 156 of the turbine blade 130. For example, the pivot axis 135 may be disposed between the first edge 150 and the center of mass 156, defining a pivotal offset distance 167 between the pivot axis 135 and the center of mass 156. A larger pivotal offset distance 167 will tend to further unbalance the turbine blade 130 and thus encourage pivotal rotation thereof. In contrast, a smaller pivotal offset distance 167 will tend to further balance the turbine blade 130 and thus discourage pivotal rotation thereof.

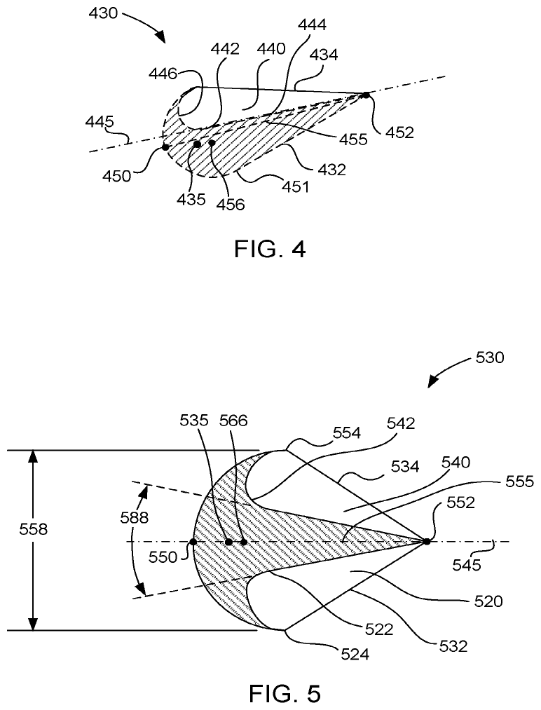

FIG. 4 illustrates a cross-sectional view, similar to that of FIG. 3C, but of an alternative turbine blade 430. The alternative turbine blade 430 includes first and second sides 432, 434, with the first side 432 including a bowed surface 451 and the second side 434 including a shallower hook shaped recess 440. A recess surface 442 of the shallower hook shaped recess 440 may be defined by a planar surface portion 444 and a curved surface portion 446. The planar surface portion 444 may extend as a flat planar surface from a second edge 452 toward a first edge 450.

In various embodiments, the planar surface portion 444 of the recess surface 442 may be disposed in an offset plane 445 that is not parallel to a chord line 455. In this way, the offset plane 445 may have an angular offset of a few degrees from a plane on which the chord line 155 is disposed, e.g. at least 2, at least 3, at least 4, at least 5, at least 6, at least 7, at least 8, at least 9, at least 10, at least 11, at least 12, at least 13, at least 14, or at least 15, for example from about 2 to about 15 degrees. In contrast to other embodiments, the planar surface portion 444 is disposed on an opposite side of the chord line 455 from the bowed surface 451.

In various embodiments, the alternative turbine blade 430 may include a pivot axis 435 that is offset from a center of mass 456. For example, the pivot axis 435 may be disposed between the first edge 450 and the center of mass 456, defining a pivotal offset distance between the pivot axis 435 and the center of mass 456.

FIG. 5 illustrates a cross-sectional view of a further alternative turbine blade 530. The further alternative turbine blade 530 includes first and second sides 532, 534, with a symmetrical design. In particular, both the first side 532 and the second side 534 each include a hook shaped recess 520, 540. A first recess surface 522 a first hook shaped recess 440 may be defined by a planar surface portion and a curved surface portion. Similarly, a second recess surface 542 a second hook shaped recess 540 may be defined by a planar surface portion and a curved surface portion. Both of the planar surface portions may extend as a flat planar surface from a second edge 552 toward a first edge 550, wherein an imaginary line from the first edge 550 to the second edge 552 defines a chord line 555.

A tail portion of the further alternative turbine blade 530 may define a wedge shape (i.e., a wedge-shaped portion) that expands from the second edge 552 toward the first edge 550. In this way, a thickness of each of the further alternative turbine blades 530 increases in a direction from the second edge 152 toward the first edge 150. That thickness flares out at the opposed curved portions of the first and second recess surfaces 522, 542. Distal ends 524, 554 of the opposed curved portions, furthest from the chord line 555 may define a maximum width 558 of the further alternative turbine blade 530. Without being limited by theory, the wedge shape may improve functioning and harness air flow on both the windward and leeward sides of the further alternative turbine blade 530. The wedge-shaped portion may be defined by a wedge angle 588 that corresponds to an angle between the flat planar surface of the first recess surface 522 and the flat planar surface of the second recess surface 542. Various embodiments may use a particular drag ratio for the wedge-shaped portion, which is defined by a ratio of a length of the linear wedge-shape portion over a thickness of a thickest portion thereof. The drag ratio may be at least 2-to-1, at least 2.5-to-1, at least 3-to-1, at least 3.5-to-1, or at least 4-to-1, at least 4.5-to-1, at least 5-to-1, at least 5.5-to-1, at least 6-to-1, at least 6.5-to-1, at least 7-to-1, at least 7.5-to-1, or at least 8-to-1, or may, for example, range from any of the foregoing up to 12-to-1, up to 11.5-to-1, up to 11-to-1, up to 10.5-to-1, up to 10-to-1, up to 9.5-to-1, or up to 9-to-1.

In various embodiments, the further alternative turbine blade 530 may include a pivot axis 535 that is offset from a center of mass 566. For example, the pivot axis 535 may be disposed between the first edge 550 and the center of mass 566, defining a pivotal offset distance between the pivot axis 535 and the center of mass 566.

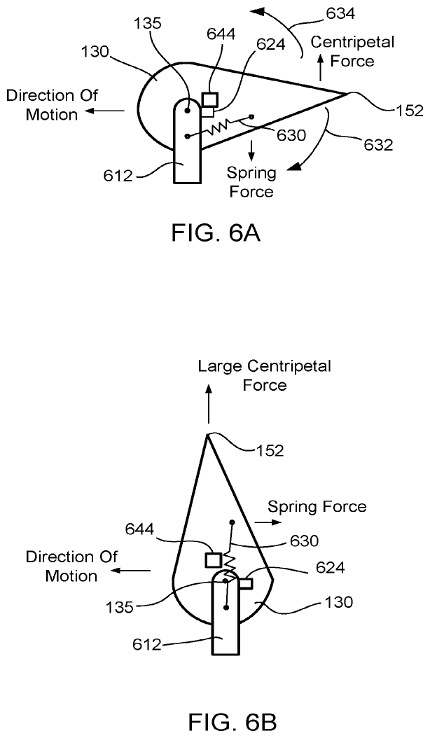

FIGS. 6A and 6B illustrate a turbine blade 130 and portion of a radially extending arm 612 of a blade support (e.g., 110, 1120) with a pivotal control system in accordance with various embodiments. The pivotal control system described herein may be similarly applied to the alternative turbine blade (e.g., 430) and/or the further alternative turbine blade (e.g., 530) described above. In various embodiments, a control spring 630 may be provided as part of the pivotal control system. The control spring 630 may be attached to a portion of the radially extending arm 612 that is radially inward from the pivot axis 135. In addition, the control spring 630 may be attached to a portion of the turbine blade 130 at a position between the pivot axis 135 and the second edge 152. Alternatively, the spring may be wrapped around the pivot axis 135 of each turbine blade 130. Springs perform well at applying a reaction moment when they experience another moment. For example, if wrapped spring is twisted, the wrapped spring tend to twist back to its original state. Thus, a spring may be wrapped around the pivot axis 135 so that twisting the wrapped spring will store a potential rotational force (moment). In this way, the control spring 630 may be configured to bias pivotal rotation of the turbine blade 130 about the pivot axis 135 in a first direction 632. In contrast, orbital movement of the turbine blade 130 around the central axis 135 may be configured to bias (e.g., through centripetal force) pivotal rotation of the turbine blade 130 in a second direction 634 about the pivot axis 135 opposite from the first direction 632. Additionally, the radially extending arm 612 may have a first rotational stop 624 in the form of a block or protrusion affixed thereon that is configured to engage a second rotational stop 644 fixed to the turbine blade 130. The first and second rotational stops 624, 644 are configured to limit pivotal rotation of the turbine blade 130 relative to the radially extending arm 612 (e.g., clockwise in the orientation shown) about the pivot axis 135.

A spring constant of the control spring 630 may be configured to prevent pivotal rotation of the turbine blade 130 about the pivot axis 135 unless a speed of the orbital movement of the turbine blade 130 around the central axis 135 exceeds a predefined threshold speed. In this way, unless the blade assembly (i.e., 105) and the individual turbine blades 130 orbit the central axis 135 faster than the predefined threshold speed, the control spring 630 will maintain the first rotational stop 624 engaged with the second rotational stop 644 (i.e., the orientation shown in FIG. 6A). However, once the speed of the orbital movement of the turbine blade 130 around the central axis 135 exceeds the predefined threshold speed, the force from the control spring 630 will be overcome and the turbine blade 130 will pivot about the pivot axis 135. The amount of pivotal rotation may correspond to the orbital movement speed. Once the orbital movement speed is high enough, a large centripetal force may be generated, which may cause the turbine blade 130 to pivot such that the second edge 152 pivots to a position furthest from the central axis (e.g., 115) of the blade assembly (e.g., 105).

Alternatively, rather than a control spring 630 various embodiments may use a pneumatic piston or other biasing element that connects a portion of the radially extending arm 612 to a portion of the turbine blade 130 in a way that biases pivotal rotation of the turbine blade 130 about the pivot axis 135 in the first direction 632.

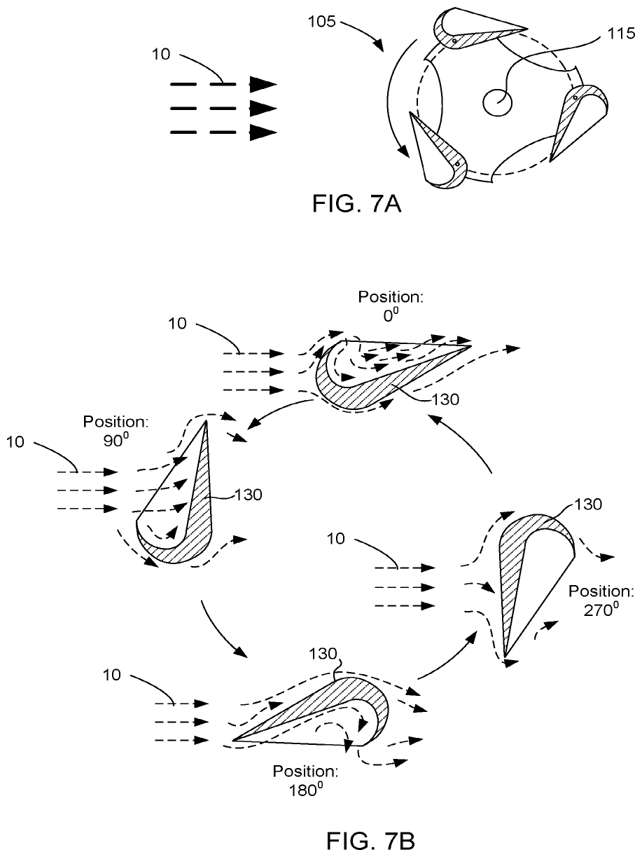

FIG. 7A illustrates a cross-sectional top view of the blade assembly 105 rotating below a predefined threshold speed. As shown, the blade assembly 105 is configured to rotate about a central axis 115. In the orientation shown, the rotation may be in a counter-clockwise direction. The rotation of the blade assembly 105 means all three turbine blades 130 orbit around the central axis 115. As the turbine blades 130 orbit the central axis, centripetal force may bias the turbine blades 130 to pivot so that the tail ends thereof start to face radially outward from the central axis 115. However, at relatively low speeds the centripetal force may not be high enough to cause such pivotal movement, thus the turbine blades 130 may remain in the pivotal positions shown when the rotation of the blade assembly 105 remains at or below relative low speeds. An exemplary prevailing wind 10 is also shown to illustrate how at any given time, each of the different turbine blades 130 will have a different orientation relative to the prevailing wind.

FIG. 7B illustrates four (4) different positions of a single one of the turbine blades 130 shown in FIG. 7A as that turbine blade 130 orbits around the central axis 115. In particular, FIG. 7B shows positions at zero-degrees (0°), ninety-degrees (90°), one hundred eighty-degrees (180°), and two hundred seventy-degrees (270°), which positions start at a top of the orbit (i.e., in the orientation shown) and follow in a counter-clockwise direction in ninety-degree (90°) increments. In some of the orbital positions, the airflow getting caught in the hook shaped recess (e.g., 140) may produce an increased drag, which promotes pivotal movement of the turbine blade 130 back toward a start position. The start position may correspond to one in which the first rotational stop (e.g., 624) is engaged with the second rotational stop (e.g., 644), such as the orientation shown in FIG. 6A. Encouraging the turbine blade 130 back to the start position may help propel the turbine blade 130 along the orbital path and reduce wear on bearing supporting the pivot axis (e.g., 115).

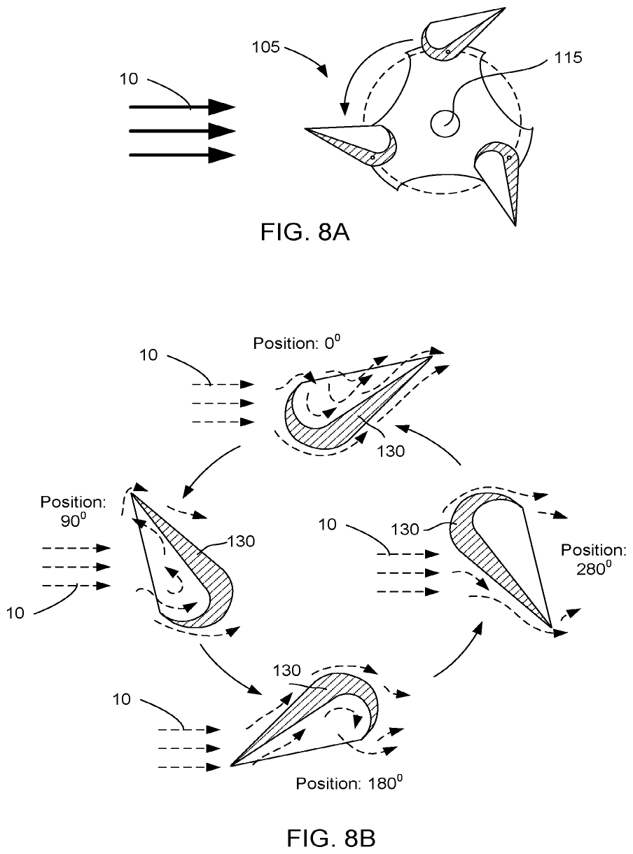

FIG. 8A illustrates a cross-sectional top view of the blade assembly 105 rotating above the predefined threshold speed. Like FIGS. 7A and 7B, the blade assembly 105 is configured to rotate about a central axis 115. Since the blade assembly 105 is rotating at a speed above the predefined threshold speed, centripetal force is high enough to cause pivotal movement of the individual turbine blades (e.g., 130). In this way, the turbine blades no longer remain in the start positions. An exemplary prevailing wind 10 is also shown to illustrate how at any given time, each of the different turbine blades 130 will have a different orientation relative to the prevailing wind.

FIG. 8B illustrates four (4) different positions of a single one of the turbine blades 130 shown in FIG. 8A as that turbine blade 130 orbits around the central axis 115. In particular, FIG. 8B shows positions at zero-degrees (0°), ninety-degrees (90°), one hundred eighty-degrees (180°), and two hundred seventy-degrees (270°), which positions start at a top of the orbit (i.e., in the orientation shown) and follow in a counter-clockwise direction in ninety-degree (90°) increments. In some of the orbital positions, the airflow getting caught in the hook shaped recess (e.g., 140) may produce an increased drag, which promotes pivotal movement of the turbine blade 130 back toward the start position (e.g., one in which the first rotational stop (e.g., 624) is engaged with the second rotational stop (e.g., 644), such as the orientation shown in FIG. 6A. Encouraging the turbine blade 130 back to the start position may help propel the turbine blade 130 along the orbital path and reduce wear on bearing supporting the pivot axis (e.g., 115).

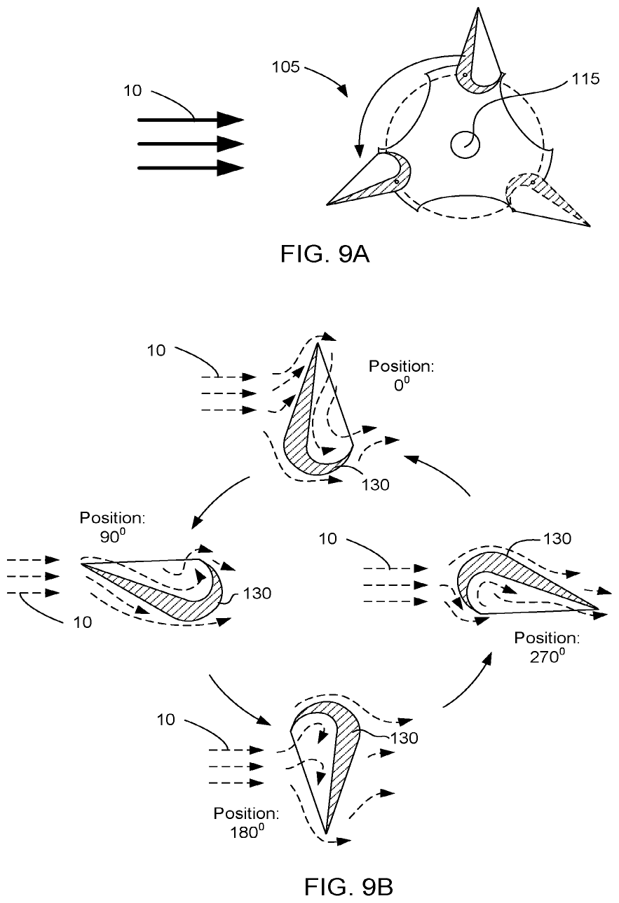

FIG. 9A illustrates a cross-sectional top view of the blade assembly 105 rotating well above the predefined threshold speed. A rotational speed of the blade assembly 105 is directly correlated to an exemplary prevailing wind 10. Like FIGS. 7A, 7B, 8A, and 8B, the blade assembly 105 is configured to rotate about the central axis 115. Since the blade assembly 105 is rotating at a speed well above the predefined threshold speed, centripetal force is extremely high and particularly high enough to cause pivotal movement of the individual turbine blades (e.g., 130) to a most extreme position. In particular, the turbine blades are not only no longer in the start positions, but are also at a radially extreme position with the tail ends of each turbine blade extending radially outward directly away from the central axis 115. In these radially extreme positions, the turbine blades are in a less aerodynamic orientation, which may itself cause the rotation to slow. In this way, the pivotal movement of the turbine blades may provide overspeed protection for the turbine assembly (105).

FIG. 9B illustrates four (4) different positions of a single one of the turbine blades 130 shown in FIG. 9A as that turbine blade 130 orbits around the central axis 115. In particular, FIG. 9B shows positions at zero-degrees (0°), ninety-degrees (90°), one hundred eighty-degrees (180°), and two hundred seventy-degrees (270°), which positions start at a top of the orbit (i.e., in the orientation shown) and follow in a counter-clockwise direction in ninety-degree (90°) increments. Due to the extreme orbital speed, more of the orbital positions force airflow to get caught in the hook shaped recess (e.g., 140), which produces an increased drag and promotes pivotal movement of the turbine blade 130 back toward the start position (e.g., one in which the first rotational stop (e.g., 624) is engaged with the second rotational stop (e.g., 644), such as the orientation shown in FIG. 6A. Encouraging the turbine blade 130 back toward the start position may help propel the turbine blade 130 along the orbital path and reduce wear on bearing supporting the pivot axis (e.g., 115).

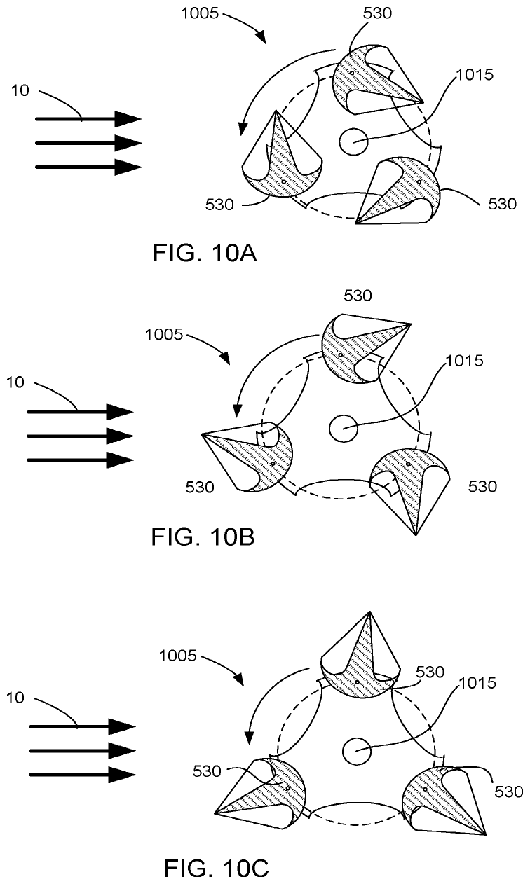

FIGS. 10A-10C illustrate cross-sectional top views of an alternative blade assembly 1005 rotating at various speeds. The alternative blade assembly 1005 includes three further alternative turbine blades 530 as described above. As shown, the further alternative blade assembly 1005 is configured to rotate about a central axis 1015. In the orientations shown, the rotation may be in a counter-clockwise direction. The rotation of the blade assembly 1005 means all three further alternative turbine blades 530 orbit around the central axis 1015. As the turbine blades 530 orbit the central axis, centripetal force may bias the turbine blades 530 to pivot so that the tail ends thereof start to face radially outward from the central axis 1015.

With reference to FIG. 10A, the alternative blade assembly 1005 is illustrated as rotating below a predefined threshold speed. At relatively low speeds, such as those below the predefined threshold speed, the centripetal force may not be high enough to cause pivotal movement, thus the turbine blades 130 remain in the pivotal positions shown. An exemplary prevailing wind 10 is also shown to illustrate how at any given time, each of the different turbine blades 130 will have a different orientation relative to the prevailing wind.

With reference to FIG. 10B, the alternative blade assembly 1005 is illustrated as rotating above the predefined threshold speed. At speeds above the predefined threshold speed, the centripetal force may be high enough to cause pivotal movement, thus the turbine blades 530 start pivoting. An exemplary prevailing wind 10 is also shown to illustrate how at any given time, each of the different turbine blades 130, in different pivotal positions will have a different orientation relative to the prevailing wind.

With reference to FIG. 10C, the alternative blade assembly 1005 is illustrated as rotating well above the predefined threshold speed. At speeds well above the predefined threshold speed, the centripetal force may be high enough to cause the most extreme pivotal movement. An exemplary prevailing wind 10 is also shown to illustrate how at any given time, each of the different turbine blades 130, in the most extreme pivotal positions will have a different orientation relative to the prevailing wind. Furthermore, as described above, when wind speed increases a vertical axis turbine may rotate too fast, resulting in overspeed which can have undesirable effects such as damage to the vertical axis turbine or risk of shedding parts during operation. Therefore, in various embodiments, vertical axis turbines according to the disclosure may be configured to reduce the risk of overspeed, by pivoting and changing the orientation of the turbine blades relative to a central axis of rotation when the speed of rotation is above a safe speed.

It will be understood that the various parts of vertical axis turbines according to the disclosure may comprise any material useful for vertical axis turbines. For example, the blades, blade supports, blade support arms, shaft, etc., may comprise metal (e.g. aluminum, steel, alloys), fiberglass, or a polymeric material, for example Acrylonitrile butadiene styrene (ABS), polytetrafluoroethylene (PTFE), polyvinyl chloride (PVC), polyvinylidene fluoride (PVDF), ethylene tetrafluoroethylene (ETFE), and/or fiber-reinforced polymeric material, or any combination of suitable materials.

Vertical axis turbines according to this disclosure may be particularly useful in tidal areas, as a water application. Tidal areas are known for having fairly regular fluid currents, which the vertical axis turbines may use to harvest energy.

Additionally, the vertical axis turbines can be connected to various mechanical and/or electrical systems to transfer mechanical energy to other devices. For example, the turbines can be connected to generators for generating electricity from the mechanical energy collected from wind. In another example, the turbines can be connected to mechanical systems, such as pumps or momentum storage systems.

In various embodiments, the turbine blades (e.g., 130, 430, 530 in FIGS. 1-5) may be formed out of a flexible material, which could allow the cross-sectional area of the turbine blade to reduce when the individual turbine blade is moving against the fluid, and which could also allow the cross-sectional area to increase when each turbine blade is in the portion of its rotation where it is moving along with the wind. For example, a thickness of one or more parts of the wedge-shaped portion of the turbine blades (e.g., 130, 430, 530 in FIGS. 3C, 4, 5) may change (i.e., reduce or increase). As a further example, a thickness of the widest part of the cross-sectional area, such as between the wedge-shaped portion and the hook-shaped portion forming the hook-shaped recess (e.g., 140, 440, 520, 540 in FIGS. 3C, 4, 5), may be reduced or increase from the hook-shaped portion bending inward, outward, or otherwise changing shape. This may have the effect of changing the difference in drag coefficients between turbine blades moving into the wind and turbine blades moving against the wind.

In various embodiments, the hook-shaped recess (e.g., 146, 446, 522, 542 in FIGS. 3C, 4, 5) may be attached to the middle section of the turbine blade (e.g., 130, 430, 530 in FIGS. 1-5) via a spring-loaded hinge, which could provide a similar affect as constructing the turbine blade out of a flexible material, allowing the cross-sectional area of the turbine blade to reduce when the individual turbine blade is moving against the wind and which could also allow the cross sectional area to increase when each turbine blade is in the portion of its rotation where it is moving along with the wind.

In various embodiments, the turbine blades may or may not be perpendicular to the support surface on which the base support structure (e.g., base 170) is resting and/or secured (e.g., the ground, part of a building, structure, the sea floor, or any other support surface, structure, and/or mechanism). In particular, various embodiments may strive to maintain the turbine blades perpendicular to the fluid flow, which may not be parallel to the support surface. For example, at elevations close to the support surface, the angle of fluid flow may range from about 4° to 40°, such as from about 5° to 35°, from about 6° to 30°, or from about 7° to 25° from such solid surface, and in one embodiment may range from 9° to 23° from the solid surface. Elevations close to the support surface may be defined from a fluid mechanics perspective as anywhere within the boundary layer of the fluid flow and the support surface, which is created by a no-slip condition. is the distances considered “close to the support surface” may be dependent on scaling and the material and shape of the support surface. Such distances could be as much as 500 feet in some cases or as little as a few inches in others. In order to increase the likelihood of remaining perpendicular to the fluid flow, the turbine blades may or may not be parallel to each other and may be at any angle relative to the nearest support surface as long as they are perpendicular or close to perpendicular to the direction of fluid flow when each turbine blade is in the portion of its rotation such that it is furthest upstream in the fluid flow.

Certain implementation examples are described in the following numbered examples:

### Example 1

A vertical axis turbine comprising a blade support configured to rotate about a central axis; and two or more turbine blades secured to the blade support and configured to orbit the central axis during rotation of the blade support around the central axis, wherein each of the two or more turbine blades includes a first edge opposed to a second edge, wherein the first edge is rounded and the second edge is sharp relative to the first edge, and includes first and second sides that extend between the first and second edges, wherein at least one of the first and second sides includes a hook shaped recess, is configured to pivot relative to the blade support about a pivot axis that is offset from the central axis.

### Example 2

The vertical axis turbine of example 1, wherein a cross-section of a portion of each of the two or more turbine blades defines a wedge shape that expands from the second edge toward the first edge.

### Example 3

The vertical axis turbine of any one of examples 1 and 2, wherein a thickness of each of the two or more turbine blades increases in a direction from the second edge toward the first edge.

### Example 4

The vertical axis turbine of any one or more of examples 1-3, wherein the first and second sides extend between first and second ends of the respective turbine blade, wherein at least one of the first and second ends is pivotally secured to the blade support.

### Example 5

The vertical axis turbine of any one or more of examples 1-4, wherein the blade support comprises separate first and second blade supports, wherein the first blade support pivotally supports the first side and the second blade support pivotally supports the second side.

### Example 6

The vertical axis turbine of any one or more of examples 1-5, wherein the at least one of the first and second sides that includes the hook shaped recess includes one or more ribs that divide the hook shaped recess into separate cavities.

### Example 7

The vertical axis turbine of any one or more of examples 1-6, wherein the hook shaped recess is configured to redirect airflow greater than 90 degrees and less than 180 degrees.

### Example 8

The vertical axis turbine of any one or more of examples 1-7, wherein the pivot axis is offset from a center of mass of the respective turbine blade.

### Example 9

The vertical axis turbine of any one or more of examples 1-8, wherein the pivot axis is disposed between the first edge and a center of mass of the respective turbine blade.

### Example 10

The vertical axis turbine of any one or more of examples 1-9, further comprising: a control spring configured to bias pivotal rotation of the turbine blade about the pivot axis in a first direction, wherein orbital movement of the turbine blade around the central axis is configured to bias pivotal rotation of the turbine blade in a second direction about the pivot axis opposite from the first direction.

### Example 11

The vertical axis turbine of example 10, wherein a spring constant of the control spring is configured to prevent pivotal rotation of the turbine blade about the pivot axis unless a speed of the orbital movement of the turbine blade around the central axis exceeds a predefined threshold.

### Example 12

The vertical axis turbine of any one or more of examples 1-11, further comprising a rotational stop on each of the two or more turbine blades and configured to limit pivotal rotation of the respective turbine blade about the pivot axis.

### Example 13

The vertical axis turbine of any one or more of examples 1-12, wherein the pivot axis is parallel to the central axis.

### Example 14

The vertical axis turbine of any one or more of examples 1-13, wherein the hook shaped recess is on the second side, wherein a chord line of each turbine blade connects points on the first and second edges furthest from one another, wherein a surface of the hook shaped recess is disposed on the opposite side of the chord line as the first side of the respective turbine blade.

### Example 15

The vertical axis turbine of any one or more of examples 1-14, wherein both the first and second sides each include separate hook shaped recesses.

### Example 16

The vertical axis turbine of any one or more of examples 1-15, wherein a cross-section of each of the two or more turbine blades is symmetrical.

### Example 17

A vertical axis turbine comprising: a blade support configured to rotate about a central axis; and two or more turbine blades secured to the blade support and configured to orbit the central axis during rotation of the blade support around the central axis, wherein each of the two or more turbine blades: is configured to pivot relative to the blade support about a pivot axis that is offset from the central axis, includes a first edge that is rounded and a second edge, opposed to the first edge, that is sharp relative to the first edge, and includes first and second sides that extend between the first and second edges, wherein each of the first and second sides includes a hook shaped recess.

### Example 18

A vertical axis turbine comprising: a blade support configured to rotate about a central axis; and two or more turbine blades secured to the blade support and configured to orbit the central axis during rotation of the blade support around the central axis, wherein each of the two or more turbine blades: is configured to pivot relative to the blade support about a pivot axis that is offset from the central axis, includes a first edge that is rounded and a second edge, opposed to the first edge, that is sharp relative to the first edge, and includes first and second sides that extend between the first and second edges, wherein the first side includes a surface that bows away from a chord line that extends from the first edge to the second edge, wherein the second side includes a hook shaped recess.

### Example 19

A vertical axis turbine according to any one of examples 1-18 which is a wind turbine.

### Example 20

A vertical axis turbine according to any one of examples 1-18 which is a water turbine. It will be apparent to those skilled in the art that various modifications and variations can be made in the compositions and methods according to the disclosure without departing from the spirit or scope of the disclosure. Thus, it is intended that the disclosure cover such modifications and variations.

The terms “a,” “an,” and “the” are understood to encompass the plural as well as the singular, whether or not so stated, unless expressly indicated otherwise.

The term “and/or” should be understood to include both the conjunctive and the disjunctive. For example, “A and/or B” means “A and B” as well as “A or B.”

All numbers herein are to be understood as being modified in all instances by the term “about,” meaning within +/−5% of the indicated number, whether or not so stated, unless expressly indicated otherwise.

As used herein, all ranges provided are meant to include every specific range within, and combination of sub ranges between, the given ranges. Thus, a range from 1-5, includes specifically 1, 2, 3, 4, and 5, as well as sub ranges such as 2-5, 3-5, 2-3, 2-4, 1-4, etc. Further, every endpoint of any range disclosed herein is expressly disclosed as a separate embodiment. Thus, a range from 1-5 expressly discloses both “1” and “5.”

1. A vertical axis turbine comprising:
a blade support configured to rotate about a central axis; and
two or more turbine blades secured to the blade support and configured to orbit the central axis during rotation of the blade support around the central axis, wherein each of the two or more turbine blades:
includes a first edge opposed to a second edge, wherein the first edge is rounded and the second edge is sharp relative to the first edge, and
includes first and second sides that extend between the first and second edges, wherein at least one of the first and second sides includes a hook shaped recess,
is configured to pivot relative to the blade support about a pivot axis that is offset from the central axis.

2. The vertical axis turbine of claim 1, wherein a cross-section of a portion of each of the two or more turbine blades defines a wedge shape that expands from the second edge toward the first edge.

3. The vertical axis turbine of claim 1, wherein a thickness of each of the two or more turbine blades increases in a direction from the second edge toward the first edge.

4. The vertical axis turbine of claim 1, wherein the first and second sides extend between first and second ends of the respective turbine blade, wherein at least one of the first and second ends is pivotally secured to the blade support.

5. The vertical axis turbine of claim 1, wherein the blade support comprises separate first and second blade supports, wherein the first blade support pivotally supports the first side and the second blade support pivotally supports the second side.

6. The vertical axis turbine of claim 1, wherein the at least one of the first and second sides that includes the hook shaped recess includes one or more ribs that divide the hook shaped recess into separate cavities.

7. The vertical axis turbine of claim 1, wherein the hook shaped recess is configured to redirect airflow greater than 90 degrees and less than 180 degrees.

8. The vertical axis turbine of claim 1, wherein the pivot axis is offset from a center of mass of the respective turbine blade.

9. The vertical axis turbine of claim 1, wherein the pivot axis is disposed between the first edge and a center of mass of the respective turbine blade.

10. The vertical axis turbine of claim 1, further comprising:
a control spring configured to bias pivotal rotation of the turbine blade about the pivot axis in a first direction, wherein orbital movement of the turbine blade around the central axis is configured to bias pivotal rotation of the turbine blade in a second direction about the pivot axis opposite from the first direction.

11. The vertical axis turbine of claim 10, wherein a spring constant of the control spring is configured to prevent pivotal rotation of the turbine blade about the pivot axis unless a speed of the orbital movement of the turbine blade around the central axis exceeds a predefined threshold.

12. The vertical axis turbine of claim 1, further comprising:
a rotational stop on each of the two or more turbine blades and configured to limit pivotal rotation of the respective turbine blade about the pivot axis.

13. The vertical axis turbine of claim 1, wherein the pivot axis is parallel to the central axis.

14. The vertical axis turbine of claim 1, wherein the hook shaped recess is on the second side, wherein a chord line of each turbine blade connects points on the first and second edges furthest from one another, wherein a surface of the hook shaped recess is disposed on the opposite side of the chord line as the first side of the respective turbine blade.

15. The vertical axis turbine of claim 1, wherein both the first and second sides each include separate hook shaped recesses.

16. The vertical axis turbine of claim 1, wherein a cross-section of each of the two or more turbine blades is symmetrical.

17. A vertical axis turbine comprising:
a blade support configured to rotate about a central axis; and
two or more turbine blades secured to the blade support and configured to orbit the central axis during rotation of the blade support around the central axis, wherein each of the two or more turbine blades:
is configured to pivot relative to the blade support about a pivot axis that is offset from the central axis,
includes a first edge that is rounded and a second edge, opposed to the first edge, that is sharp relative to the first edge, and
includes first and second sides that extend between the first and second edges, wherein each of the first and second sides includes a hook shaped recess.

18. A vertical axis turbine comprising:
a blade support configured to rotate about a central axis; and
two or more turbine blades secured to the blade support and configured to orbit the central axis during rotation of the blade support around the central axis, wherein each of the two or more turbine blades:
is configured to pivot relative to the blade support about a pivot axis that is offset from the central axis,
includes a first edge that is rounded and a second edge, opposed to the first edge, that is sharp relative to the first edge, and
includes first and second sides that extend between the first and second edges, wherein the first side includes a surface that bows away from a chord line that extends from the first edge to the second edge, wherein the second side includes a hook shaped recess.

19. A vertical axis turbine of claim 1, which is a wind turbine.

20. A vertical axis turbine of claim 1, which is a water turbine.
